(19) United States
(12) Patent Application Publication
(10) Pub. No.: US 2003/0198131 A1
(43) Pub. Date: Oct. 23, 2003

(54) Method and apparatus for locating underground water pipes

(76) Inventor: Tommy Chandler, Carthage, TX (US)

Correspondence Address: David G. Henry, 900 Washington Avenue, P.O. Box 1470, Waco, TX, 76701, US

(21) Appl. No.: 10/126,443

(22) Filed: Apr. 19, 2002

(51) Int. Cl. G03B 42/06

(52) U.S. Cl. 367/7

(57) ABSTRACT

The invention is of an acoustical pipe location system and method of use, by which hidden water pipes may be located. The system and method involve the introduction of low frequency acoustic vibrations into known portions of pipes, or pipe network components which are known to be connected with a pipe, a portion of which is to be located.

### BACKGROUND OF THE INVENTION

1. Field of the Invention

The present invention relates to methods and apparatuses for locating hidden, underground objects by remote detection.

2. Background Information

Locating underground or otherwise hidden pipes can be a frustrating, time consuming, expensive and even destructive process. This holds even greater truth when one focuses on the now ubiquitous PVC and other non-metallic pipe.

Whether a pipe is buried underground, or in a wall or ceiling, locating a span of pipe is often necessary to address a leak, splice a new fitting, inject tracing fluids, or any number of other purposes. Metal detectors are of no help when the search-for pipe is non-metallic. Furthermore, one pipe of interest may be found amidst a number of other pipes of no interest.

The product of difficulty in precisely locating a pipe, aside from wasted time and labor expense, often comes in the form of unnecessarily excavated landscape, excessive wall or ceiling covering damage, or even damage to surrounding pipes which are of no interest to the person seeking the subject pipe.

In view of the above, it would well serve plumbing contractors, property owners, city utilities, and others who may, from time to time, need to locate a pipe which cannot be found by visual means, to provide some method and associated apparatus by which such a pipe can be reliably and precisely located. Such an apparatus and associated method would ideally be one which is, of course, non-destructive, inexpensive to implement, and easily retrofitted to existing pipes and pipe networks.

### SUMMARY OF THE INVENTION

In view of the above, it is an object of the present invention to provide an apparatus or system by the use of which pipes hidden from visual detection can be located.

It is another object of the present invention to provide a method by which pipes hidden from visual detection can be located.

It is another object of the present invention to provide a method by which pipes hidden from visual detection can be located, which method avoids excavation or other property destruction in excess of that required for actual access to the subject pipe.

It is another object of the present invention to provide a method by which a pipe hidden from visual detection can be located, which method utilizes acoustic energy which is disseminated through the pipe from a component known to be connected to such pipe, and detected using acoustic detection means.

It is another object of the present invention to provide a method by which pipes hidden from visual detection can be located, which method involves the use of apparatuses which can be, as applicable, installed or used with existing pipes and pipe networks.

In satisfaction of these and related objects, the present invention provides a system (multiple apparatuses) and associated method of use for locating pipes which are hidden from view and not susceptible to detection by metal detection devices. The apparatuses and associated methods of use involve transmitting acoustical waves through to-be-located pipes via components (water meters, fittings, etc.) which are known to be connected to the subject pipe. The acoustical energy is in the form of low frequency vibrations which are known for their ready propagation with very limited attenuation through water.

The present system and associated method of use utilizes acoustic generating means which produce vibrations in the approximate 200 Hz frequency range (100 Hz up to 1000 Hz—“low frequency, acoustic vibrations” —with the best mode lying in the use of vibrations at approximately 200 Hz for optimal propagation), and impart such vibrations to a pipe, a remote span of which, is desired to be located. An acoustic detector, with attached signal strength indicator means (such as a visual display), and suitably filtered for selectively detecting acoustic waves in the subject frequency range, is used to home in on the subject span of pipe.

The detection device appears much as a conventional metal detector, and is passed over the ground, or along a wall, under or in which a sought-after pipe is thought to reside. When the user observes a peak in the detector's detection of the target vibrations, he or she knows that the precise location of the pipe has been revealed.

### BRIEF DESCRIPTION OF THE DRAWINGS

FIG. 1 is a perspective view of a water pipe with an acoustic generator unit of the present system attached for propagating sound waves into the pipe.

FIG. 2 is a perspective view of the vibration detection unit of the present system shown in use for locating a buried pipe.

### DETAILED DESCRIPTION OF THE PREFERRED EMBODIMENT

Implementation of the present invention involves getting suitable vibrations into pipes or pipe networks which are to be located for repair, etc., and then sensing the vibrations for such location.

Low frequency vibrations are known for their ability to travel vast distances through water. Research by the present inventor reveals that whales, for example, can communicate over hundreds, or even thousands of miles via “voice” transmissions in the 200 Hz range. It is upon this principle that the choice was made for the present invention to propagate vibrations in the 200 Hz range through pipes and pipe networks as part of the present method for locating buried pipes. once vibrations are transmitted to the water in pipes, it will propagate for miles through the pipes. As will be discussed later, these vibrations can then be detected for locating the pipe that carries the water which, in turn, has carried the vibrations from their source (a known component of the pipe network in which the sought after pipe is known to reside).

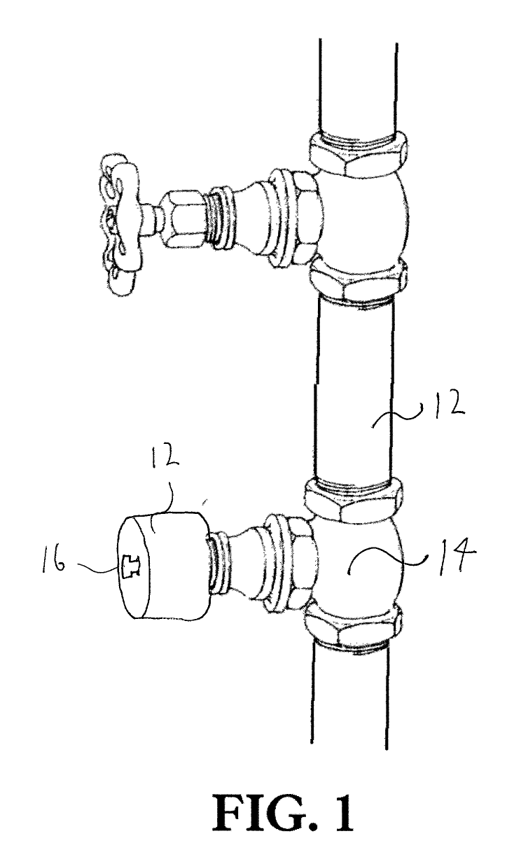

Referring to FIG. 1, imparting the desired vibrations to a pipe 10 or network component, and, therefore, to the water that resides therein, can be relatively straight forward. Such can also involve permanent installation of sound generating components, or involve the use of temporarily used components (not shown in the figures).

Referring again to FIG. 1, one approach within the scope of the present invention lies in incorporating miniature sound generator modules 12 in-line with either fittings 14 or water meters (not shown). Such modules 12 are very small electronic, IC-based devices which, in current use, generate sounds for everything from talking toys to cellular telephones. Sound generator modules 12 can be fabricated to produces sounds of a near infinite variety, and can be custom designed to produce a desired sound such as, for example, a single-pitch, 200 Hz tone as is desired for the present invention. The placement of a sound generator module 12 in a water meter, valve assembly, etc. will follow simple reason—such would be placed such that its vibrations would be most easily and directly transmitted into the water stream that flows through the unit.

Miniature sound generator modules 12 are battery operated, and, for obvious reasons, it would not be desirable for them to run constantly. Therefore, switching schemes would be involved in actuating the sound generator modules only when a pipe location is to be carried out. Such switching schemes could range from a simple, physical switch 16 (as shown in FIG. 1) which is accessible to a user, or some more elaborate setup with radio or acoustically actuated switches (not shown). Any such switching arrangement would be within the skills of an electrical component designer of reasonable skill, and will not here be set forth in detail.

An alternative means for imparting the desired sound into a pipe or pipe network lies in the mechanical generation of desired sound waves. This can be accomplished though electrically-powered, mechanical vibrator units, small electric motors which are coupled with mechanical linkages for generating impulses at the desired frequency, or even, perhaps, bimorph actuators incorporated into assemblies for transmitting their vibrations into audibly perceptible vibrations and propagating such vibrations through the water in water pipes and networks.

In short, any method or mechanism that can generate vibrations in the 200 Hz range, and be placed in a position for transmitting such vibrations into a specific point on a water pipe, a fitting, a valve, a meter, etc. (at a “point of vibration introduction”), will satisfy the function of this element of the present invention.

A still further alternative for generating the necessary vibrations is taught in the Perkins patent (U.S. Pat. No. 6,359,371) which is incorporated here by reference. The Perkins vibrator units, in certain described, miniature embodiments, would be well-suited for incorporation into such components as water meters or valve assemblies which are in fluid communication with to-be-located pipes. It should be observed that Perkins speaks of his units emitted sounds only down to around the 300 Hz level, but such would still be in the range of utility for the present invention, and well within the scope thereof.

Another patent which teaches useful miniature vibrator technology which could be used in the context of the present invention is the Morita patent, U.S. Pat. No. 6,323,758, which is also incorporated here by reference.

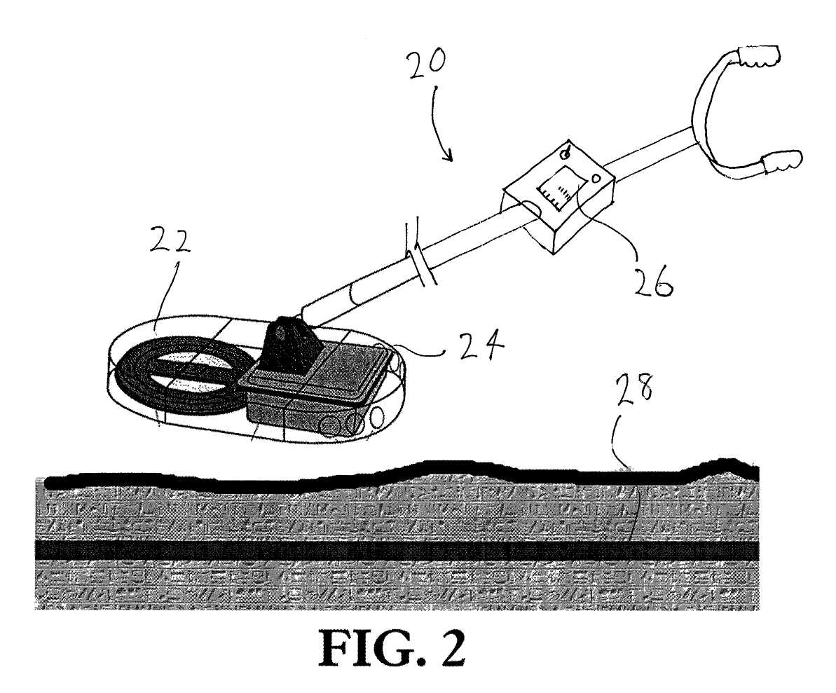

Once the above-described vibrations are transmitted into the pipe network, detecting them at one or more “points of vibration detection” becomes the issue. Referring to FIG. 2, a metal detector-like device (“pipe detector unit”) 20 is envisioned in which is incorporated a suitable sound detector 22 and a spectrum analyzer 24. The sound detector 22 detects audible sound (including the 200 Hz vibrations in an underlying water pipe), and the spectrum analyzer 24 is tuned to detect the specific, target frequency and display its amplitude on its graphic display screen 26.

Spectrum analyzer 24 will have suitable band pass filtering for isolating the 200 Hz (or other chosen frequency) vibrations as would be uniquely present in a sought after pipe 28 , while substantially “ignoring” extraneous, ambient noise.

An example of technology that will be useful for the pipe detector unit (and even more so if it can be miniaturized) is illustrated by the spectrum analyzer, model QF4032 which is available from Autogas-Boertzler s.r.o; Industriezone Bor/Block 2/101; CZ34802 BOR-VYSOCANY/CZECH REPUBLIC; phone CZ+420 607 724 221 phone CZ+420 606 472 949.

As the technical specifications of this particular spectrum analyzer indicates, its settings range from 0-2210 MHz, with a center frequency span of ∓100 Hz. This will allow detection of pipe vibration emanations with a graphical display of their intensity which, or course, correlates to the proximity of their source. By moving the pipe locator unit to a point on the ground where the strength of vibrations it the target frequencies are maximized on the display of the spectrum analyzer, one has located the point under which a pipe carrying the test vibrations is buried.

Because most spectrum analyzers are designed to monitor electromagnetic waves, rather than acoustical waves, either a microphone and transducer combination for converting sound waves into impulses which can be analyzed by the spectrum analyzer, or a microphone which produces spectrum analyzer-readable signals at the outset will be required. Selecting and, as applicable, interfacing of such components is well within the skill set of persons reasonably skilled in the spectrum analysis field.

It is the belief of the current inventor that dynamic microphones (magnetic) are preferred over condenser type microphones as the pickup device for the pipe detector unit. Condenser microphones are believed to be too sensitive for the sounds which are of no relevance for the current purposes. At present, SHURE brand, model SM57 microphones are believed to be a suitable example.

An alternative to the dynamic microphone and transducer combination for generating signals which may be processed by spectrum analyzers lies in the use of ICP sensor (accelerometer) technology. ICP sensors involve the use of constant current across a piezoresistive sensor element, and a miniature amplifier internal to the sensor. Such sensors can, among other things, pick up vibrations, through the creation of a high impedance charge which will be output to a recording or analyzing instrument (such as a spectrum analyzer). ICP sensors are the subject of proprietary technology licensed by and available from PCB Piezotronics, Inc. of Depew, N.Y. A vibration amplifier, an example of which is also available from PCB Piezotronics, Inc. would likely be needed to condition and amplify the signal for input into, and analysis for graphic display by the spectrum analyzer.

A teaching from U.S. Patents relating to acoustical detection, applicable portions of which may be incorporated into the pipe location unit of the present invention, is that of the Laurent patent—U.S. Pat. No. 5,889,731 which is incorporated herein by reference. A sensor like that of Laurent's teaching may be used in the pipe detection unit of the present invention.

In summary, a device constructed according to the present invention, and the method of use thereof, also within the scope of the present invention, has the capacity for saving contractors, city utilities, and homeowners (collectively) millions of dollars each year. “Wild goose chases” in locating the correct buried pipe can be eliminated, so long as the vibration generating portion of the present invention is actuated in a pipe network component which is known to contain the suspect pipe.

Using the present invention, pipes can be precisely located, thereby avoiding larger-than-needed excavations, with the possible damage to irrelevant pipes, power lines, buried communications cables, etc.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. A system for enabling the non-visual detection and location of water pipes comprising:
vibration generating means for generating low frequency acoustical vibrations and propagating said low frequency acoustical vibrations into a water pipe and a point of vibration introduction;
sound detection means for detecting said low frequency acoustical vibrations at a point of vibration detection, remote from said point of application, said sound detection means having signal output means for generating a signal which is proportional to the amplitude of the detected low frequency acoustical vibrations;
signal strength display means attached to said sound detection means for displaying human perceptible indicia which indicates a range of amplitudes of said detected acoustical waves from a low amplitude to a high amplitude limit.

2. The system of claim 1 wherein said low frequency acoustical vibrations are at an approximately 200 Hz frequency.

3. A method for the non-visual detection and location of water pipes comprising the steps of:
selecting an acoustical pipe location system, itself comprising:
vibration generating means for generating low frequency acoustical vibrations and propagating said low frequency acoustical vibrations into a water pipe and a point of vibration introduction;
sound detection means for detecting said low frequency acoustical vibrations at a point of vibration detection, remote from said point of application, said sound detection means having signal output means for generating a signal which is proportional to the amplitude of the detected low frequency acoustical vibrations;
signal strength display means attached to said sound detection means for displaying human perceptible indicia which indicates a range of amplitudes of said detected acoustical waves from a low amplitude to a high amplitude limit;
attaching said vibration generating means to a pipe network components which is connected, at least indirectly, to a length of pipe to be located;
actuating said sound detection means and said signal strength display means;
passing said sound detection means over a surface under or behind which said pipe to be located is suspected to be located;
observing indications of said signal strength display means and stopping said passing when said indications indicate a maximum apparent measurement of said vibrations by said sound detection means, and noting the location where said maximum apparent measurement occurred as an indication of the location of said pipe.

4. The method of claim 3 wherein said low frequency acoustical vibrations are at an approximately 200 Hz frequency.
